(19) United States
(12) Patent Application Publication
(10) Pub. No.: US 2006/0146713 A1
(43) Pub. Date: Jul. 6, 2006

(54) Method and apparatus for improving measurement accuracy for voice-over-packet bearer network interface

(76) Inventors: Steven L. Makowski, Naperville, IL (US); Douglas J. Botkin, Aurora, IL (US); Joseph J. Kott, Aurora, IL (US)

Correspondence Address: FAY SHARPE/LUCENT, 1100 SUPERIOR AVE, SEVENTH FLOOR, CLEVELAND, OH, 44114, US

(21) Appl. No.: 11/026,591

(22) Filed: Dec. 30, 2004

(51) Int. Cl. H04L 12/26; H04B 1/44

(52) U.S. Cl. 370/236; 370/282

(57) ABSTRACT

A system is provided for improving measurement accuracy for voice-over-packet bearer network interfaces. The presently described embodiments address performance measure inaccuracies that occur during the disconnect sequence of an internet protocol bearer network logical connection. This technique accomplishes this task by generating and transmitting a last packet indicator to ensure that the endpoints of the path are synchronized.

### BACKGROUND OF THE INVENTION

This invention relates to a method and apparatus for improving measurement accuracy for voice-over-packet bearer network interfaces. More particularly, the presently described embodiments address performance measure inaccuracies that occur during the disconnect sequence of an internet protocol (IP) bearer network logical connection. This technique accomplishes this task by generating and transmitting a last packet indicator to ensure that the endpoints of the path are synchronized.

While the invention is particularly directed to the art of improving measurement accuracy for internet protocol bearer network logical connections, and will be thus described with specific reference thereto, it will be appreciated that the invention may have usefulness in other fields and applications. For example, the invention may be used in other call control sequences involving, for example, connection transfers, conferences, . . . etc.

By way of background, measurements are used by an IP network gateway to monitor the logical bearer channels that are supported by the gateway. Both usage and performance measurements are typically supported by an IP network gateway. Usage measurements typically count the number of connection attempts, the number of connection completions, etc. Performance measurements typically count the number of packets sent/received, the number of packets lost, the number of jitter buffer over/under-runs, the number of unexpected packets received, etc. Inaccuracies in the performance measurements can occur because of inadequate synchronization, on the logical bearer channel, between the endpoints involved in the connection.

That is, connection set-up and tear down in an IP network is accomplished using signaling messages between the endpoints that support the required bearer connectivity. The signaling messages may flow in the same network (over the same network route or a different network route) or a different network than the bearer channels that will be used to support the connection. In either case, the signaling messages use a separate and distinct protocol from that which is used to establish, move, or to take down the bearer connection. As such, a delay exists between a request for action on the signaling interface by one endpoint and the execution, of the requested action, on the bearer interface by another endpoint. This delay causes inaccuracies in performance measurements at the connection endpoints on the bearer interface.

More particularly, referring to FIG. 1, a stable bearer connection in an IP network is shown. The IP network 10 includes an endpoint A and an endpoint B, labeled 12 and 14 respectively. A problem arises in this configuration when a disconnect message is sent from endpoint A (12) to endpoint B (14).

More particularly, with reference now to FIG. 2, disconnect message 16 is shown as being transmitted from endpoint A (12) to endpoint B (14). In this way, endpoint A (12) drops its bearer connection by closing its bearer network logical connection and marks the port as inactive or idle. Until endpoint B (14) receives and processes the disconnect message, endpoint B (14) continues to generate packets and send them toward endpoint A (12). Consequently, endpoint A (12) continues to experience arriving packets on an inactive or idle port. As a result, endpoint A (12) is counting unexpected packets that are received in the now inactive or idle bearer network logical connection port and, therefore, generating destination unreachable responses for these unexpected packets. Adversely, endpoint B (14) is expecting incoming packets from endpoint A (12) at some time interval on its active bearer network logical connection port. Consequently, endpoint B (14) unnecessarily counts jitter buffer under runs when packets do not arrive during the expected interval.

The above description identifies a root cause for measurement inaccuracies on interfaces between endpoints involved in a stable internet protocol connection during a disconnect sequence.

The present invention contemplates a new and improved method and apparatus that resolves the above-referenced difficulties and others.

### SUMMARY OF THE INVENTION

A method and apparatus for improving measurement accuracy for voice-over-packet bearer network interfaces are provided.

In one aspect of the invention, a method of disconnecting a call between a first endpoint and the second endpoint through a packet network comprises transmitting a disconnect message and a single last packet indicator (LPI), referred to as the first last packet indicator, from the first endpoint to the second endpoint, detecting the first last packet indicator (LPI) by the second endpoint, transmitting an acknowledgement message and a single last packet indicator (LPI), referred to as the second last packet indicator, from the second endpoint to the first endpoint in response to the first last packet indicator (LPI) and closing an input port at the first endpoint in response to the second last packet indicator (LPI).

In another aspect of the invention, the method further comprises closing the output port of the second endpoint upon transmitting the second last packet indicator.

In another aspect of the invention, the method further comprises transmitting a message acknowledging receipt of the second last packet indicator (LPI) by the first endpoint.

In another aspect of the invention, a method for disconnecting a call between a first endpoint and a second endpoint through a packet network comprises transmitting a disconnect message and last packet indicator from the first endpoint to the second endpoint and detecting the last packet indicator (LPI) by the second endpoint.

In another aspect of the invention, the method further comprises transmitting an acknowledgement message and a second last packet indicator from the second endpoint to the first endpoint in response to the last packet indicator.

In another aspect of the invention, the method further comprises closing an input port on the first endpoint in response to the second last packet indicator.

In another aspect of the invention, the method further comprises closing an output port at the first endpoint upon transmission of the last packet indicator.

In another aspect of the invention, a means is provided to implement the methods of the present invention.

In another aspect of the invention, a system within a packet network comprises a first endpoint operative to transmit a disconnect message and a last packet indicator and to close an output port, and a second endpoint operative to detect the last packet indicator.

In another aspect of the invention, the system wherein the second endpoint is further operative to transmit an acknowledgement and a second last packet indicator in response to the last packet indicator.

In another aspect of the invention, the system wherein the first endpoint is operative to close an input port in response to the second last packet indicator.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a network;

FIG. 2 illustrates further operation of the network of FIG. 1;

FIG. 3 illustrates a network into which the present invention may be implemented;

FIG. 4 is a flow chart illustrating a method according to the present invention;

FIG. 5 illustrates operation of the network of FIG. 3 according to the present invention;

FIGS. 6 illustrates operation of the network of FIG. 3 according to the present invention;

FIG. 7 illustrates operation of the network of FIG. 3 according to the present invention;

FIG. 8 illustrates operation of the network of FIG. 3 according to the present invention; and,

FIG. 9 is an illustration of a message header format according to at least some embodiments of the present invention.

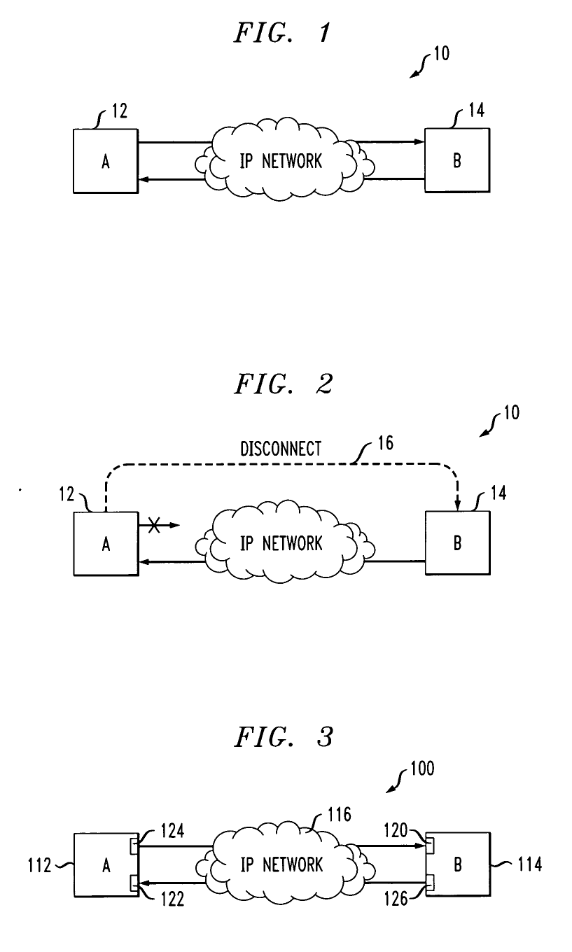

### DETAILED DESCRIPTION OF THE PREFERRED EMBODIMENTS

The presently described embodiments provide a technique to improve the accuracy of performance measurements for Internet Protocol (IP) bearer network interfaces. The invention addresses performance measurement inaccuracies that occur during the disconnect sequence of an IP bearer network logical connection.

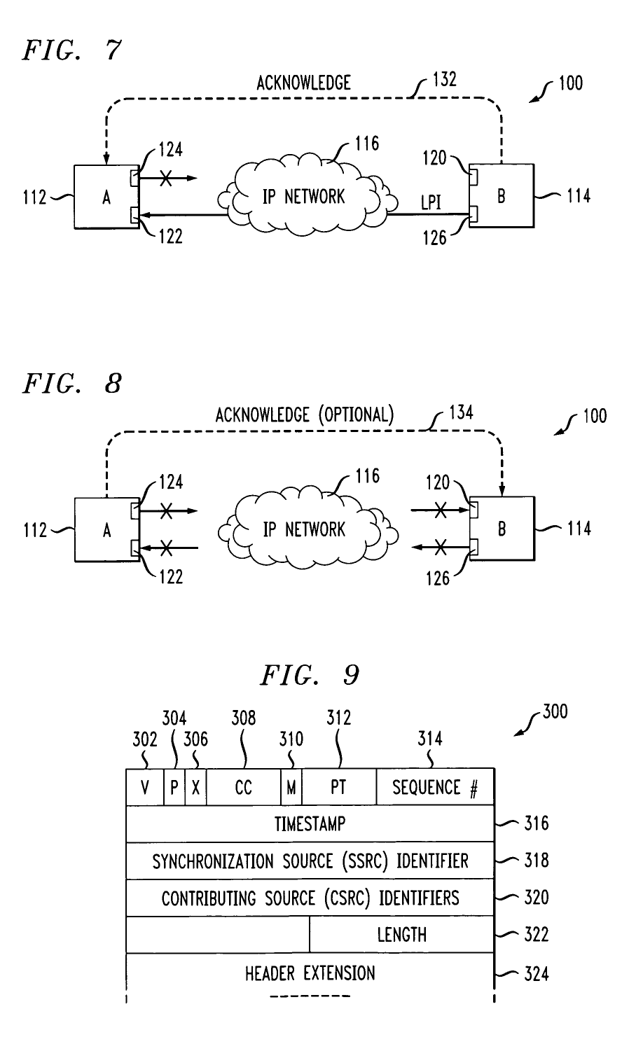

Referring now to the drawings wherein the showings are for purposes of illustrating the preferred embodiments of the invention only and not for purposes of limiting same, FIG. 3 provides a view of a network into which the present invention may be implemented. As shown, FIG. 3 illustrates two switching endpoints on a packet network such as an IP network, i.e., endpoint A (112) and endpoint B (114). Each endpoint supports bearer connectivity to the IP network through its own gateway device and can originate and/or terminate logical connections. It will be appreciated that a signaling association (as shown representatively in FIGS. 5 and 7) is established between the endpoints, using either in-band or out-of-band techniques, for the purpose of establishing logical connections between the endpoints. Any appropriate signaling protocol may be used between the endpoints to establish a logical connection between the originating and terminating endpoints, e.g., endpoint A (112) and endpoint B (114), respectively.

As shown, the system 100 comprises the endpoints A (112) and B (114) and an Internet Protocol (IP) network 116, establishing a bearer path. The endpoint A (112) is connected to the IP network 116 by way of a gateway and a switch/router. As those of skill in the art will understand, there may be a variety of different gateways and switch/routers connecting the endpoint A (112) to the IP network 116. Likewise, the endpoint B (114) is connected to the IP network 116 through a gateway and a switch/router. Again, multiple gateways and switch/routers may establish connections between the endpoint B (114) and the IP network 116.

It will be understood by those of skill in the art that configuration of the system 100 may take a variety of forms. For example, the IP network 116 may be replaced by another form of a packet network. The endpoints may also take a variety of forms to accomplish appropriate functionality necessary in the implementation of a communication network. For example, the endpoints may be realized in any network element that originates or terminates an IP packet associated with a call, e.g., a switch, an IP gateway, an IP phone, . . . etc. In this regard, the endpoints may comprise multiple gateways and each gateway may comprise multiple ports (logical channels) that are available for communication functions. In this regard, the endpoints have IP addresses and UDP port numbers associated therewith.

It should be understood that, although the drawings only show signaling between endpoint A (112) and endpoint B (114), the signaling actually travels from endpoint A through the IP network (via routers and other switching elements) to endpoint B, and vice-versa. Signaling and bearer channels may travel through the same IP network or they may travel through different IP networks.

It should be appreciated that methods according to the present described embodiment may be implemented in a variety of manners. Specific implementation may depend on the actual networks used and the objectives of the network(s) design.

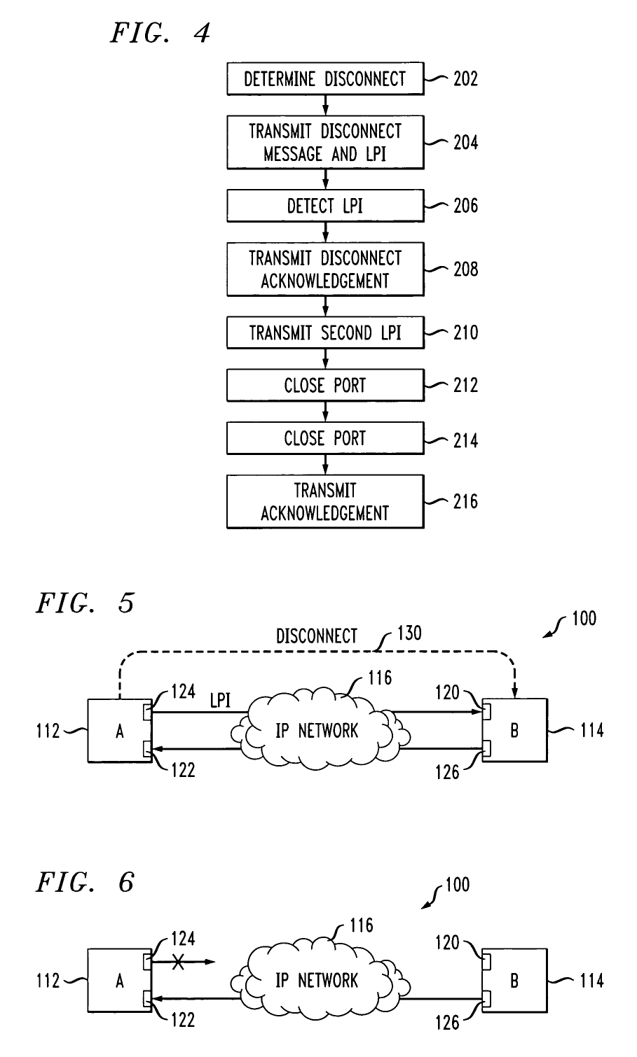

However, in operation, with reference now to FIG. 4, a method 200 may be implemented in the system. In this method, endpoint A (112) initially determines that a disconnect message should be sent (at 202). Endpoint A (112) then sends the disconnect message over the signaling path and a last packet indicator (LPI) in, for example, a last packet of data to endpoint B (114) (at 204). In this example process, endpoint B (114) detects the last packet indicator (at 206). Detection of the LPI may occur in a variety of known manners and will depend on the form of the last packet indicator (L PI) and the form of transmission. Endpoint B (114) then sends a disconnect acknowledgement over the signaling path to endpoint A (112) and, over the bearer channel, also sends a last packet indicator to endpoint A (112) indicating the last packet that it is sending (at 208 and 210). Endpoint B (114) then closes the output port (at 212). Upon receiving and detecting the last packet indicator from endpoint B (114), endpoint A (112) then closes the input port (at 214). Again, detection of the last packet indicator (LPI) may occur in a variety of manners. Optionally, endpoint A (112) may also send an acknowledgement message back to endpoint B (114) on the signaling path (at 216).

The above-described method is simply an example of a messaging sequence that may occur according to the present invention. Of course, in any form of the method, a last packet indicator (LPI) is used to provide synchronization between the endpoints so that unnecessary packets are not erroneously counted by the measuring facilities at each endpoint.

One variation of the method 200, as described in FIG. 4, may be that endpoint A (112) may close its input port 122 upon sending the last packet indicator to endpoint B (114). In this case, endpoint A (112) will also notify its measurement facilities to discontinue counting packets en route from endpoint B (114). This, of course, will prevent the unnecessary counting of packets. It should also be appreciated that variations such as this may negate the need for endpoint B (114) to send a last packet indicator (LPI) back to endpoint A (112). It may also negate the need for further acknowledgements to be exchanged between endpoints A (112) and B (114).

It should be further understood that the present invention may be implemented using a variety of hardware configurations and software techniques. The precise configurations and techniques may vary from implementation to implementation. As an example, however, it is to be appreciated that the methods described in connection with the present invention may be implemented in software that resides at the endpoints and may well be distributed throughout the system, as is appropriate.

With reference back now to FIG. 3, the endpoints include interfaces (e.g., input ports 120,122 and output ports 124,126) modified to accommodate the techniques of the present invention. These interfaces may take the form of logical UDP ports. For example, incoming bearer network logical connections of these endpoints into input ports 120 and 122, in one form, is modified to be able to identify a last packet indicator (LPI) and also to modify the measurement accuracy technique in accordance with recognition of the last packet indicator (LPI). For example, the interface will simple inhibit counting that is accomplished to determine measurement accuracy. This may be implemented through modification of a field programmable gate array (FPGA) device at the interface. In addition, use of a last packet indicator (LPI) will, in at least one form, require a change in the form of the bearer network logical connections (e.g. output ports 124,126) of the endpoints to allow for generation and transmission of a last packet indicator (LPI).

As an example of the method described above, referring now to FIGS. 5-8, a method for either endpoint of a connection to notify the other endpoint, over the logical bearer connection, that it has stopped sending packets is detailed. The notification is passed between the endpoints using a last packet indicator (LPI) carried within the last packet that the initiating endpoint sends to the other endpoint(s) of the connection. It is this notification that synchronizes the endpoints relative to disconnection to avoid measurement inaccuracies.

With reference to FIG. 5, endpoint A (112) sends a disconnect message 130 to endpoint B (114) over the signaling path. Endpoint A (112) includes a last packet indicator (LPI) in the last packet that is sent over the bearer path to endpoint B (114). In one form, endpoint A (112) does not close the UDP port (e.g., input port 122) until it receives a last packet indicator (LPI) from endpoint B (114). This will prevent endpoint A (112) from detecting unexpected packets and creating extraneous performance counts.

With reference to FIG. 6, endpoint B (114) inhibits performance counting on the UDP port (e.g., input port 120) when it detects the LPI from endpoint A (112). This will prevent the jitter buffer at endpoint B (114) from under-running and creating extraneous performance counts.

With reference to FIG. 7, endpoint B (114) sends a disconnect acknowledge message 132 to endpoint A (112) over the signaling path. Endpoint B (114) includes a last packet indicator (LPI) in the last packet it sends over the bearer path to endpoint A (112). Endpoint B (114) closes the UDP port (output port 126).

With reference to FIG. 8, endpoint A (112) sends an acknowledge message 134 to endpoint B (114) over the signaling path. As indicated, this acknowledgement message is optional. Endpoint A (112) closes the UDP port (e.g., port 122).

The method provided above also eliminates extraneous ICMP DESTINATION UNREACHABLE messages from being sent during the disconnect sequence. These messages result whenever a packet has been sent to a logical port that is closed.

The last packet indicator (LPI) may be implemented in a variety of manners. However, in at least some of the embodiments, the last packet indicator (LPI) is implemented within the header of an RTP protocol message. In this regard, with reference now to FIG. 9, a header format 300 is illustrated. The header format 300 shows that the header has a variety of fields that are useful for a variety of different reasons.

For example, the header format 300 shows a version bit (V) 302 that identifies the version of the real time protocol (RTP) that is being used. A padding (P) bit 304 is used to indicate whether the packet contains one or more additional padding octets at the end of the message which are not a part of the payload. An extension bit (X) 306 is also provided. The extension bit (X) indicates whether an extension for the header is provided. A contributing source (CSRC) count (CC) field 308 is also included within the header 300. The CC bit 308 contains a number of CSRC identifiers that follow the fixed header. A marker bit (M) 310 is provided to allow significant events such as frame boundaries to be marked in the packet stream. This is a profile defined field. A payload type (PT) field 312 is provided to identify the format of the RTP payload and determine its interpretation by the application. A sequence field 314 is provided. This field increments by one (1) for each RTP data packet that is sent and may be used by the receiver to detect packet loss and restore packet sequence. A time stamp 316 is included within the header format. This field reflects the sampling instant of the first octet in the RTP data packet. The synchronization source (SSRC) identifier 318 identifies the synchronization source. The contributing source (CSRC) identifier 320 identifies the contributing source for the payload contained in the packet. The number of these identifiers is provided in the CC field 308.

For packets containing header extensions, the length of the header extension is provided in field 322. Notably, the header extension is provided in the field 324. If the extension bit is not set, however, the extension field is not provided.

Given this header format 300 or similar such formats, it may be manipulated to provide the contemplated last packet indicator (LPI). In one form, a new payload type (PT) identifier 312 may be defined in the RTP header. Changing the payload type from its normal connection value to the last packet indicator (LPI) value can be used to indicate that the sender has concluded transmission of packets. This can be detected by simply reading or processing the PT identifier 312 in the normal course of processing the packet.

In another form, the payload extension bit (X) 306 may be set in the RTP header. The header extension 324 will then contain a parameter (e.g., last packet indicator (LPI)) in its payload that is used to indicate that the sender has concluded the transmission of packets. Again, detection of the last packet indicator (LPI) may occur in this form by simply reading or processing the extension bit (X) 306 and, if necessary, the header extension 324.

Apart from the use of the exemplary header format, the last packet indicator (LPI) may be implemented in other ways. For example, if silence suppression is supported, the existing silence indicator methodology may be used to support the required LPI functionality. Transmission of the silence indicator is currently used to prevent jitter buffer errors over the life of an active connection. This invention extends the use of the silence indicator to also be supported by the last packet sent during a disconnect sequence. This could be accomplished by forcing transmission of the silence indicator upon transmission of the disconnect message. A software routine could be implemented to do so. Of course, the silence indicator will then be detected at the other endpoint in known manners.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of disconnecting a call between a first endpoint and the second endpoint through a packet network, the method comprising:
transmitting a disconnect message and a first last packet indicator from the first endpoint to the second endpoint;
detecting the last packet indicator by the second endpoint;
transmitting an acknowledgement message and a second last packet indicator from the second endpoint to the first endpoint in response to the first last packet indicator; and,
closing an input port at the first endpoint in response to the second last packet indicator.

2. The method as set forth in claim 1 further comprising closing the output port of the second endpoint.

3. The method as set forth in claim 1 further comprising transmitting a message acknowledging receipt of the second last packet indicator by the first endpoint.

4. A method for disconnecting a call between a first endpoint and a second endpoint through a packet network, the method comprising:
transmitting a disconnect message and last packet indicator from the first endpoint to the second endpoint; and,
detecting the last packet indicator by the second endpoint.

5. The method as set forth in claim 4 further comprising transmitting an acknowledgement message and a second last packet indicator from the second endpoint to the first endpoint in response to the last packet indicator.

6. The method as set forth in claim 4 further comprising closing an input port on the first endpoint in response to the second last packet indicator.

7. The method as set forth in claim 4 further comprising closing an output port at the first endpoint upon transmission of the last packet indicator.

8. A system of disconnecting a call between a first endpoint and the second endpoint through a packet network, the system comprising:
means for transmitting a disconnect message and a last packet indicator from the first endpoint to the second endpoint;
means for detecting the last packet indicator by the second endpoint;
means for transmitting an acknowledgement message and a second last packet indicator from the second endpoint to the first endpoint in response to the last packet indicator; and,
means for closing an input port at the first endpoint in response to the second last packet indicator.

9. The system as set forth in claim 8 further comprising means for closing the output port of the second endpoint.

10. The system as set forth in claim 8 further comprising means for transmitting a message acknowledging receipt of the second last packet indicator by the first endpoint.

11. A system for disconnecting a call between a first endpoint and a second endpoint through a packet network, the system comprising:
means for transmitting a disconnect message and last packet indicator from the first endpoint to the second endpoint; and,
means for detecting the last packet indicator by the second endpoint.

12. The system as set forth in claim 11 further comprising means for transmitting an acknowledgement message and a second last packet indicator from the second endpoint to the first endpoint in response to the last packet indicator.

13. The system as set forth in claim 11 further comprising means for closing an input port on the first endpoint in response to the second last packet indicator.

14. The system as set forth in claim 11 further comprising means for closing an input port at the first endpoint upon transmission of the last packet indicator.

15. A system within a packet network comprising:
a first endpoint operative to transmit a disconnect message and a last packet indicator and to close an input port; and,
a second endpoint operative to detect the last packet indicator.

16. The system as set forth in claim 15 wherein the second endpoint is further operative to transmit an acknowledgement and a second last packet indicator in response to the last packet indicator.

17. The system as set forth in claim 15 wherein the first endpoint is operative to close an input port at the first endpoint in response to the second last packet indicator.
